(19) United States
(12) Patent Application Publication
(10) Pub. No.: US 2022/0380059 A1
(43) Pub. Date: Dec. 1, 2022

(54) Piston Wings

(71) Applicant: George Pul, Las Vegas, NV (US)

(72) Inventor: George Pul, Las Vegas, NV (US)

(21) Appl. No.: 17/334,800

(22) Filed: May 31, 2021

(51) Int. Cl. B64D 27/04

(52) U.S. Cl. CPC B64D 27/04

(57) ABSTRACT

Piston Wings has high lift airfoils mounted on a linear reciprocal motion mechanism for a propeller driven propulsion engine. Piston Wings, in linear reciprocal motion shuttling back and forth in a generally horizontal plane, has airfoils oriented at optimum angle of attack to generate maximum lift forces; and the lift forces, when vectored, are turned into variable thrust forces for takeoffs, landings, and flights of vehicles. Piston Wings in flight has the appearance of legendary magic or flying carpets.

### FIELD

The present invention of Piston Wings relates generally to a propeller driven propulsion engine, and particularly to a linear reciprocal motion propeller driven propulsion engine, with propellers of high lift airfoils shuttling back and forth in linear reciprocal motions on a generally 2D horizontal plane.

### BACKGROUND OF THE INVENTION

Piston Wings of the present invention is inspired by PPRW documented in patent U.S. Pat. No. 10,988,236 B2 granted on Apr. 27, 2021 with high lift airfoils in elevation view reciprocating back and forth in a generally 2D horizontal plane to give Piston Wings an appearance of a legendary magic or flying carpet. Piston Wings has a piston slider crank mechanism with a crankshaft being powered in rotations which in turn powering pistons through sliders or connecting rods in back and forth reciprocating motions, in exactly the reverse of an internal combustion engine. Piston Wings props or propellers in reciprocal translation 2D plane motions, like PPRW in 3D pipe profile rotating in cylindrical motions, propels directional airflows for trust forces normal to the generally 2D horizontal plane, and when vectored by rotating the generally 2D plane, the propelled thrust forces are turned into variable thrust forces for takeoffs, landings, and flights of vehicles.

### SUMMARY OF THE INVENTION

Piston Wings of the present invention is inspired by PPRW documented in patent U.S. Pat. No. 10,988,236 B2 granted on Apr. 27, 2021 with high lift airfoils in elevation view reciprocating back and forth in a generally 2D horizontal plane to give Piston Wings an appearance of a legendary magic or flying carpet. Piston Wings has a piston slider crank mechanism with a crankshaft being powered in rotations which in turn powering pistons through sliders or connecting rods in back and forth reciprocating motions, in exactly the reverse of an internal combustion engine. Piston Wings props in reciprocal forward and backward 2D plane motions, like PPRW in 3D pipe profile rotating in cylindrical motions, propels directional airflows for trust forces normal to the generally 2D horizontal plane, and when vectored by rotating the generally 2D plane, the propelled thrust forces are turned into variable thrust forces for takeoffs, landings, and flights of vehicles, and comprising: a wing assembly mounted on and powered by a linear reciprocal motion mechanism assembly.

The wing assembly consists a high lift airfoil and a stationary shaft, with the stationary shaft fixed mounted to, and the high lift airfoil pitch oriented by the mechanism assembly. The high lift airfoil is attached by rotational joints along, rotated and pitch oriented around the stationary shaft. The high lift airfoil has an appearance similar to a curved segment of a large portion of a semi-circle with a segment chord and a segment chord plane generally aligned to a 2D horizontal plane. The wing assembly with the high lift airfoil and the stationary shaft is shuttled back and forth in a linear reciprocal motion generally parallel to the segment chord and 2D horizontal plane by the linear reciprocal motion mechanism assembly.

The linear reciprocal motion mechanism assembly consists a linear reciprocal motion mechanism and a pitch orientation mechanism. Being powered, the linear reciprocal mechanism sets in motion the high lift airfoil and the stationary shaft of the wing assembly, shuttling back and forth in linear reciprocal motions generally parallel to the segment chord and 2D horizontal plane; while the pitch orientation mechanism sets in rotation motion of the high lift airfoil, pitch orienting the high lift airfoil to an optimum angle of attack for maximum propelled lift force normal to the generally 2D horizontal plane. The maximum lift force, when vectored by rotating the generally 2D horizontal plane, is turned into a variable thrust force for takeoffs, landings, and flights of vehicles.

Piston Wings is further comprised of a power and control assembly for powering and controlling the linear reciprocal motion mechanism assembly. The power and control assembly and other means and provisions required for the wing assembly mounted on the linear reciprocal motion mechanism assembly of Piston Wings of the present invention are neither novel nor unique, and are not further described.

### BRIEF DESCRIPTION OF THE DRAWINGS

FIG.1 is a schematic plan view of the preferred embodiment of the present invention. FIG. 2 is a schematic front view of the preferred embodiment of the present invention. FIGS. 3a and b are schematic reciprocal linear motion views of the wing assembly shown in FIG. 2.

### DESCRIPTION OF THE PREFERRED EMBODIMENT

Piston Wings of the present invention, a prop driven propulsion engine with high lift airfoils reciprocating back and forth in a generally 2D horizontal plane and propelling directional airflows to generate thrust forces normal to the generally 2D horizontal plane, is disclosed by a preferred embodiment, which is a simplified Piston Wings to show with clarity its features and advantages for propelling airflows to generate thrust forces. These and other features and advantages of the present invention will become more apparent to one skilled in the art from the following description and claims when read in light of the accompanying drawings for the preferred embodiment of a simplified present invention.

Unless otherwise apparent, or stated, directional references, such as “inner,” “inward,” “outer,” “outward,” “downward,” “upper”, “lower” etc., are for non-limiting descriptive purposes and intended to be relative to the orientation of a particular Piston Wings of the present invention as shown in the view of that apparatus. Parts shown in a given FIGURE are generally proportional in their dimensions; and parts shown or omitted in a given FIGURE are intended generally for clarity.

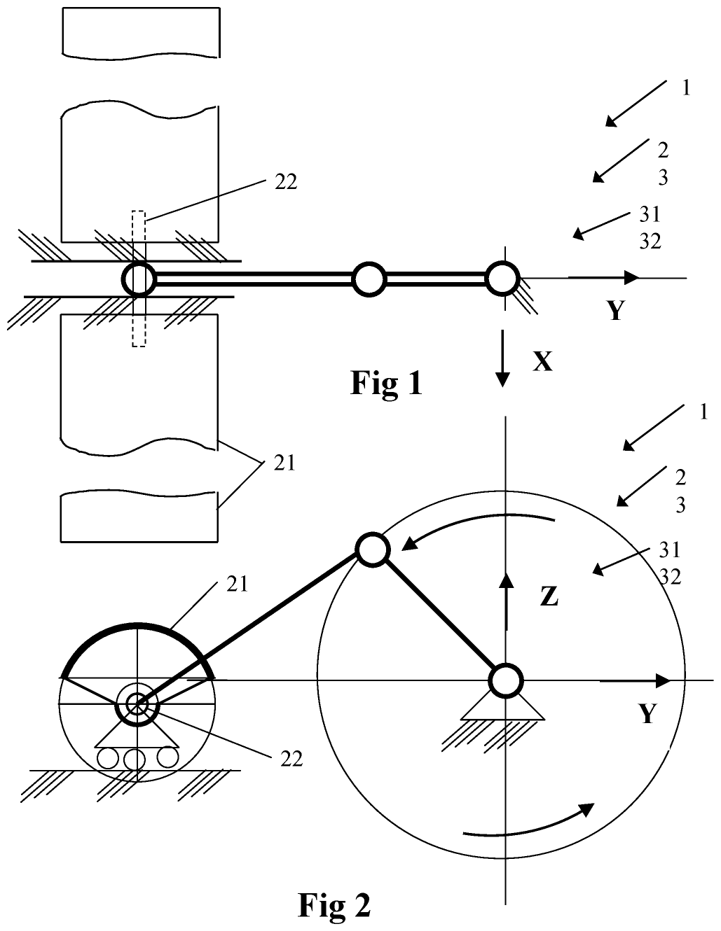

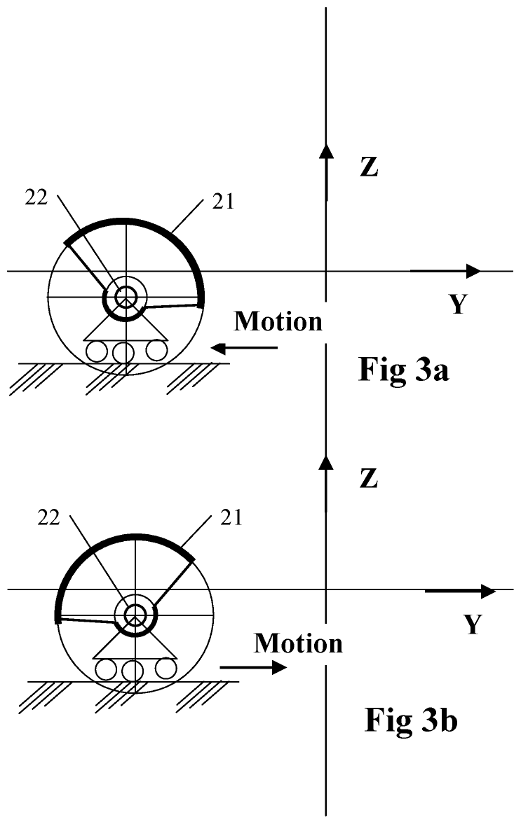

Referring to FIGS. 1 thru 3, preferred embodiment 1 of the Piston Wings of the present invention, a propeller driven propulsion engine, is comprised of two sides of a twin wing assembly 2 mounted on, powered by, and straddling to left and right hand side of a linear reciprocal motion mechanism assembly 3.

One side of the twin wing assembly 2 is consisted of a high lift airfoil 21 and a stationary shaft 22, with the stationary shaft 22 fixed mounted to, and the high lift airfoil 21 pitch oriented by the linear reciprocal motion mechanism assembly 3. The high lift airfoil 21 is attached by a rotational joint along, rotated, and pitch oriented around the stationary shaft 22. The high lift airfoil 21 has an appearance in cross section similar to a curved segment of a large portion of a semi-circle with a segment chord and a segment chord plane lying generally in a 2D horizontal plane. One side of the twin wing assembly 2 with its high lift airfoil 21 and stationary shaft 23 is shuttled back and forth in a linear reciprocal motion parallel generally to the segment chord plane and 2D horizontal plane by linear reciprocal motion mechanism assembly 3.

The linear reciprocal motion mechanism assembly 3 is consisted of a piston slider crank mechanism 31 and a pitch orientation mechanism 32. Being powered, the piston slider crank mechanism 31 sets in motion the twin wing assembly 2 in motion, shuttling back and forth in linear reciprocal motions generally parallel to the segment chord and 2D horizontal plane; while the pitch orientation mechanism 32 sets in motion the high lift airfoil 21, pitch orienting the high lift airfoil 21 to an optimum angle of attack for propelling a maximum lift or thrust force normal to the generally 2D horizontal plane. The maximum lift or thrust force, when vectored by rotating the generally 2D horizontal plane, is turned into a variable thrust force for takeoffs, landings, and flights of vehicles.

Preferred embodiment 1 of the present invention of the Piston Wings is further comprised of a power and control assembly for powering and controlling linear reciprocal motion mechanism assembly 3 of preferred embodiment 1. The power and control assembly and other means and provisions required for preferred embodiment 1 are neither novel nor unique, and are not further described.

The preferred embodiment described above is for the purpose of describing features and technical conceptions of a simplified Piston Wings of the present invention, a propeller driven propulsion engine with high lift airfoils reciprocating back and forth in a generally 2D horizontal plane to give Piston Wings an appearance of a legendary magic or flying carpet. But it should be readily apparent that the invention is not limited to the described preferred embodiment alone, and a person skilled in the art may come up with various changes and modifications consistent to the technical concept disclosed herein and within the spirit and scope of the invention. Prime examples of modifications and optimizations to the described preferred embodiment include: the shapes, sizes, and center points of high lift airfoils; high lift airfoils linear back and forth reciprocating motions moving forward and aft ward, and from side to side; multiple airfoils mounted on an elongated piston aligned linearly to the back and forth motion; and having a plurality of piston wings stacked one on top of another. Where stated, “air” is broadly meant to be any fluid medium, including water; and “aircraft” is broadly meant to be any craft, including watercraft, legendary magic or flying carpet, and flying cars. Required means, provisions, and systems for powering and vectoring propelled thrust forces—such as power motors and engines, transmission, fuel, mechanisms, and controls systems—that are neither novel nor unique systems, are not described in detail for the preferred embodiment of the present invention. Therefore, it is to be understood that modifications and variations may be utilized without departure from the spirit and scope of the invention disclosed herein, as those skilled in the art will readily understand. Such modifications and variations are considered to be within the purview and scope of the claimed invention and their equivalents.

I claim:

1. A Piston Wing, a linear reciprocal motion propeller driven propulsion engine, comprising:
a wing assembly mounted on and powered by a linear reciprocal motion mechanism assembly, wherein:
a) the wing assembly is consisted of a high lift airfoil and a stationary shaft mounted to and oriented by the linear reciprocal motion mechanism assembly; the high lift airfoil having rotational joints attached along, rotated and pitch oriented around the stationary shaft, and having an appearance similar to a curved segment of a large portion of a semi-circle with a segment chord lying in a segment chord plane generally parallel to a horizontal plane; the stationary shaft fixed mounted to, and the high lift airfoil pitch oriented by the linear reciprocal motion mechanism assembly; and
b) the linear reciprocal motion mechanism assembly is consisted of a linear reciprocal motion mechanism and a pitch orientation mechanism; being powered, the linear reciprocal motion mechanism sets in motion the wing assembly shuttling back and forth in linear reciprocal motions generally parallel to the horizontal plane, while the pitch orientation mechanism sets in motion the high lift airfoil pitched to an optimum angle of attack for propelling a maximum lift force; and the maximum lift force, when vectored, is turned into a variable thrust force for takeoffs, landings, and flights of vehicles.
